(19) United States
(12) Patent Application Publication
(10) Pub. No.: US 2007/0165818 A1
(43) Pub. Date: Jul. 19, 2007

(54) Network event driven customer care system and methods

(75) Inventors: Raghvendra G. Savoor, Walnut Creek, CA (US); Kevin Meng, San Ramon, CA (US); Peter Wong, Newark, CA (US)

Correspondence Address: MIKE ROSE, 2646 SOUTH LOOP WEST, SUITE 405, HOUSTON, TX, 77054, US

(73) Assignee: SBC Knowledge Ventures L.P., Reno, NV (US)

(21) Appl. No.: 11/327,928

(22) Filed: Jan. 9, 2006

(51) Int. Cl. H04M 3/42

(52) U.S. Cl. 379/201.12

(57) ABSTRACT

The present disclosure provides systems and methods for informing customers and taking other corrective actions upon the occurrence of a network event that may affect the provision of a network service, such as Internet Service, VOIP, VOD, IPTV etc. The system includes a processor and computer programs that contain instruction that are executed by the processor to determine the occurrence of a network event and its effect on one or more services and on the network elements and sends appropriate messages to the affected customers and call centers and updates relevant databases.

### BACKGROUND OF THE DISCLOSURE

1. Field of the Disclosure

This disclosure relates to networks that provide services to customers.

2. Description of the Related Art

Networks, such as communications networks, including packet-switched networks such as digital subscriber line (DSL) networks, cable communications networks, satellite communications networks, are utilized to provide a variety of services, such as access to Internet, Voice over Internet Protocol (VoIP), Internet Protocol Television (IPTV), Video-on-Demand (VoD), etc. Such networks typically include a backbone network that employs a variety of network elements, such as servers and routers located in various geographical areas, which elements are interconnected via high speed transport links. Additional routers and switches, such as digital subscriber line multiplexers, located in central offices in metropolitan areas are typically connected to customers over dedicated links, such as copper wires. Such networks are extremely complex, span vast geographical areas and provide the services to millions of customers. Thus, in a typical network, a number of network elements and transport links interconnect to transmit the service content to customer premise equipment (CPE).

The network elements and the transport links typically have logical and physical assignments. When a logical or physical path is broken, for example, due to a failure of a network element or a transport link or a subcomponent thereof in the path linked to a customer, a network event (also referred to as an “alarm”) is sent by a network monitoring system (which is typically a computer system, sometimes referred to in the industry as the “element management system”) to a network operations center (“NOC”). Equipment manufacturers typically categorize these network events or alarms as service affecting or non-service affecting events. These alarms are generally filtered by the EMS to avoid flooding of the network management systems.

Often, only certain categories of the service affecting events are used by the personnel in the NOC for surveillance and trouble shooting purposes. The NOC personnel often do not know the identity of the individual customers who are affected by a network event or alarm or impacted by a failure of a physical or logical path, especially if the path is part of the service provider's core network. Also, dynamic events in the network can cause the status of the network or conditions to change from a non-service affecting event to a service affecting event, or vice versa. NOC or other customer care center personnel of a service provider often react to customer complaints to determine the nature of the problems and/or to generate trouble tickets for service personnel to resolve the problems. Thus, there is a need for a system and method for more efficiently and effectively managing the network services that may be affected by or impaired due to network conditions.

### BRIEF DESCRIPTION OF THE DRAWINGS

For detailed understanding of the present invention, reference should be made to the following detailed description of an exemplary embodiment, taken in conjunction with the accompanying drawings, in which like elements have been given like numerals, wherein:

FIG. 1 shows a system for providing a network service to customers according to one embodiment of the present disclosure;

FIG. 2 shows an exemplary flow chart of a method according to one embodiment of the present disclosure; and

FIG. 3 is a diagrammatic representation of a machine in the form of computer system within which a set of instructions, when executed, may cause the machine to perform any one or more of the methodologies discussed herein.

### DETAILED DESCRIPTION OF THE EMBODIMENTS

The present disclosure provides a system and method for providing network services, including maintaining customer-to-network maps, determining impact on network and customers of network events/alarms and proactively informing customers about the impact or services and updating network databases.

The present disclosure, in one aspect, provides a computer readable medium that contains a computer program that is accessible to a processor for executing instructions in the computer program. The computer program includes a set of instructions to receive a signal relating to the occurrence of a network event, a set of instructions to determine if the network event is a service affecting event, a set of instructions to determine customers affected by the network event, and a set of instructions to send a message relating to the affected service. The computer program may further include a set of instructions to access a customer-to-network map to identify the customers affected by the network event. The computer program may also include a set of instructions that sends a message to a customer premise equipment, voice recognition system, and/or customer care database. The computer program may further include instructions to determine a change in status of the network event and to send a message relating to the change in the network status. In another aspect, the computer program may include instructions to determine an extent of the affected service, which may be a partial disruption of the service, a complete disruption of the service, or an identity of one or more network elements that are associated with the network event. The computer program further may include a set of instructions that determines the affected customers in real-time, using a predictive model, or based on historical data.

The present disclosure, in another aspect, provides a system for use in a communications network wherein the system includes a first database that stores information about network elements and transport links that provide a network service to a plurality of customers, a second database that stores information relating to the plurality of customers, and a processor that has access to a computer program and the first and second databases, and wherein the processor utilizing the computer program determines the occurrence of a network event and sends a message in response to the occurrence of the network event. The first database includes customer-to-network maps that define network paths that provide the network services to the customers. The system also determines the identity of customers that are affected by the occurrence of the network event and sends the message to the affected customers, a database that is accessible to a service representative from a remote location and/or a voice recognition system that informs customers about the service condition upon receiving a call from such customers.

The present disclosure, in another aspect, provides a method for providing a service over a communications network that includes the steps of determining occurrence of a network event, determining if the network event is a service affecting event, and initiating a response relating to customers affected by the network event. The method may determine the occurrence of the network event in real-time, by predicting the occurrence based on a predefined rule or by using historical data. In the present method, the response may include sending a message to a customer call center that is adapted to receive communication from the customers, an interactive voice recognition system that is operative to communicate with the customers, and/or the customers. The method also determines a customer-to-network map that defines network paths which provide the affected service to the customers and determines the customers which are affected by the network event from the network paths. The method also provides a database that stores relationships among a plurality of network elements that provide the service, provide a database that stores customer information, and the relationships among the network elements with the customer information to determine the customers affected by the occurrence of the network event. The customer information may include customer identification, services provided to the customers, transport links providing the services to customers, customer preferences relating to receiving notifications, identification of a customers premise equipment receiving the services, and network switches that route the services to customers. The method also determines when the network event is no longer a service affecting event and then sends a message that indicates that the service is no longer affected by the network event and updates the customer-to-network maps accordingly.

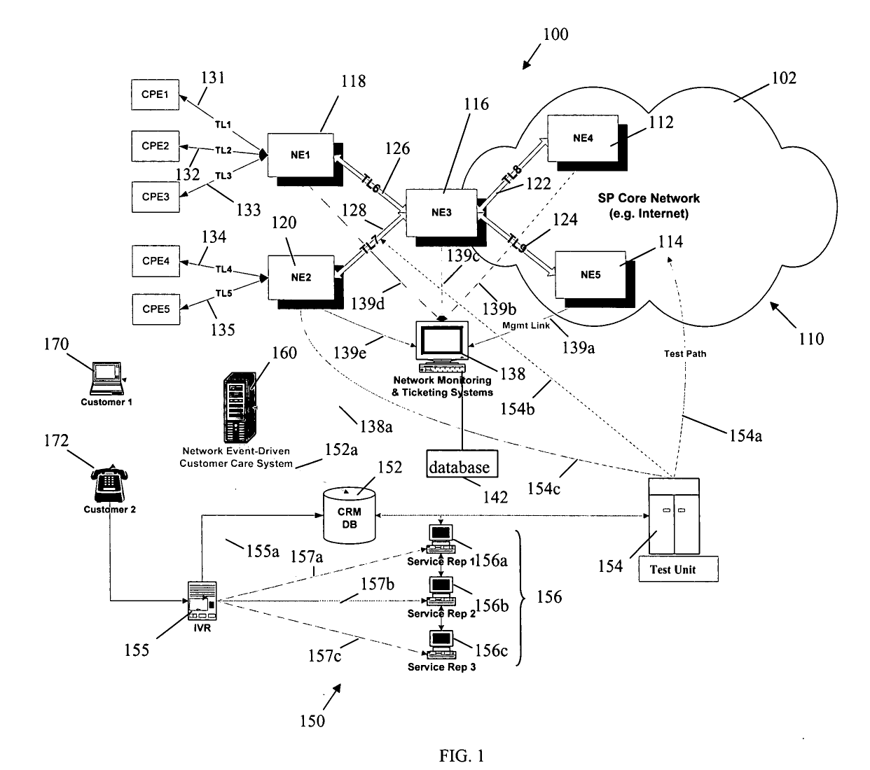

FIG. 1 shows a system 100 for providing network services according to one embodiment of the present disclosure. The system 100 is shown to include a communications network 110 that provides network services to various customers or subscribers, a customer care system 150 and a network event driven customer care system (NED system) 160, according one embodiment of the present disclosure. A typical communications network that a service provider sets up to provide services to customers (also referred to as subscribers or end users) is composed of a variety of devices, referred to herein generally as network elements (NEs), and transport links (TLs) that connect the network elements (NE) to each other and to customer premise equipment (CPE). For ease of explanation and understanding, FIG. 1 shows only a reference communications network 110. The network 110 is shown to include a backbone network 102 that includes network elements 112 (NE4), 114 (NE5) and 116 (NE3), wherein NE4 is connected to NE3 via a transport link 122 (TL8) while NE5 is connected to NE3 via a transport link 124 (TL9). Network element 118 (NE1) and network element 120 (NE2) are shown outside the core network and directly connected to customer premise equipment CPE. For example, NE1 is shown connected to CPE1, CPE2 and CPE3 while NE2 is shown connected to CPE4 and CPE5. The network 110 also is shown to include a Network Monitoring and Ticketing System 138. In this disclosure, the term network element is used in a broad sense to mean any network component including but not limited to servers, routers, switches, transport links, and subcomponents thereof.

The network 110 may be a packet-switched network, such as digital subscriber line (DSL) network, a cable network, a satellite network or any other suitable network that provides network services. The network services may include services such as Internet access, Voice over Internet Protocol (VoIP), Internet Protocol Television (IPTV), Video-on-Demand (VoD), etc. For the purpose of this disclosure the term DSL is used in a broad sense to include any such service, including but not limited to, services such as Asymmetric Digital Subscriber Line (ADSL), Single-pair High-speed Digital Subscriber Line (G.SHDSL), etc. The network elements (NEs) include a variety of servers (such as video servers, voice servers, etc.), routers, switches, and subcomponents of such elements. In the example of FIG. 1, network elements NE4 and NE5 may provide network content (video, voice, or data) to the network element NE3 via transport links TL8 and TL9 respectively. NE1 receives the network content from NE3 over the transport link 126 (TL6) and provides the network content to customer premise equipment CPE1-CPE3 via transport links 131 (TL1), 132 (TL2) and 133 (TL3) respectively. Similarly, NE2 receives the network content from NE3 via link 128 (TL7) and provides the network content to CPE4 and CPE5 via transport links 134 (TL4) and 135 (TL5) respectively.

Each network element NE and its subcomponents (such as shelves, cards and ports) typically has a logical and physical assignment in the system 100. For example, the path used to provide a service to CPE2 in the normal course may be the path from CPE2 to TL2 to NE1 to TL6 to NE3 to TL8 and then to NE4. However, if a physical or logical path is broken in this path due to, for example, a failure of one of the network elements or transport links, the network in some instances may have redundancy and can reroute the network content. In the example of FIG. 1, if the failure relates to NE4 or TL8, the network may be able to reroute the network content (traffic to NE3) via NE5 and TL9, without impacting the service to CPE1-CPE3. In such an event, the network event may be classified as a non-service affecting event. On the other hand, if the physical path TL6 is broken, then the network 110 is unable to reroute the services to CPE1-CPE3. In such an instance, the network event may be classified as a service affecting event. For the purpose of this disclosure any event that affects or may affect the provision of a service over the network 110 is referred to as a “network event” or an “alarm.”

In the present disclosure, in one aspect, network events are typically categorized or classified as service affecting or non-service affecting events. For example, a problem with NE1, which may be switch, such as a digital subscriber line multiplexer (DSLAM) that has dedicated connections to CPE1-CPE3, may be such that it affects the quality of each of the services provided to each of the CPE1-CPE3 or may be such that it only affects one of such services provided to the customers.

Still referring to FIG. 1, the network 110 includes one or more network monitoring systems (“NMS”) 138 that monitor the various elements of the network 110. The network monitoring system 138 includes one or more servers, associated computer programs, a database 142, and a graphical user interface (GUI). The NMS 142 is coupled to the various network elements as shown by links 139a-139e. In one aspect, the network elements, such as the elements NE1-NE5, periodically or continuously provide information about the health of such elements to the NMS 138. Network elements NE1 and NE2 also may provide information about CPEs to which they are connected. In another aspect, the NMS 138 may be configured to query the performance information from the various network elements and transport links periodically or continuously in real-time. The database 142 stores information about the various network elements and transport links and provides an overall real-time view of the network resources via a detailed GUI. NMS 138 tracks and displays the inventory of the network elements, links, transport paths and both logical and physical assignments for each of the elements. When a network event or an alarm occurs, NMS 138 filters or determines whether the event is a service affecting event or a non-service affecting event.

The network 110 further includes a network customer care system 150 that comprises a customer relations management (CRM) database 152, an Interactive Voice Recognition (IVR) system 155, a test system 154 and a customer service representative system 156 having a plurality of service representative stations, such as stations 156a-156c. The customer care system 150 further includes a network event driven system (NED system) 160, which may be a server having associated memory, database and computer programs and GUI.

As shown in FIG. 1, the NED system 160 is operatively coupled to the NMS 138 via a link 138a, to CRM database 152 via a link 152a and to IVR 155 via a link 155a. The system 160 also is operatively coupled to or is adapted to communicate directly with customers, such as customers 170 and 172. CRM database 152 stores information about each of the customers and the network elements, links and paths that are associated with such customers. Such information may include a customer identifier (such as a telephone number), a logical identifier (such as a user identification number), Point to Point Protocol over Ethernet (PPPOE) address, and serial number of the customer CPE. The database 152 also includes information about the network elements that are associated with each CPE. The database stores information about each NE and its subcomponents (such as shelves, cards and ports of a DSLAM or another switch or router) and information about the transport links (which may be logical).

In one aspect, the network event driver system 160 through the databases 142 and 152 maintains an object model of entities and data that may be organized in distinct layers and their interactions with various relational tables, maps and rules. In one aspect, the NED system 160 may organize the data in various layers, such as a (i) network and event layer, (ii) service level layer, and (iii) customer layer. It should be noted that these layers merely represent one example of organizing the data and any other suitable way to organize the data may be utilized for the purpose of this disclosure.

The network and event layer may include objects, tables, maps that instantiate all the entities and events in the network 110 and includes the network elements and their subcomponents, transport links and (logical and physical), and events and alarms (including description, status, etc. of each alarm) and their association to the specific network elements and/or the transport links.

The service layer may include a list of services provided over the network 110, such as DSL services, transport links, such as Permanent Virtual Connection (PVC) or Virtual Local Area Network (VLAN) and physical transport links, such as DS3 circuits, and optical carrier-level, such as OC3 connections. The database 152 further includes information about the services provided to the customers, such as Internet access, VoIP, IPTV, VoD, etc and customer preferences regarding receiving notification from the service providers. A customer may request that he/she be notified by one or more methods if there is a change in service or for other reasons. For example, the request notification may be made via a land telephone, e-mail, or over another handheld device, such as a PDA. The database 152 stores all such information. In addition the database 152 includes test data that may be periodically or continuously obtained by a test tool unit 154. The test tool unit is operatively connected to the various network components as shown by the exemplary links 154a-154c. The test tool unit 154 may receive data about the performance of the network components including but not limited to, shorts and opens in the transports links, bandwidth, load on a line or equipment, SONET (Synchronous Optical Network), etc. and service impact characteristics or rules of the service affecting network events that may occur with a specific service.

The customer layer may include information about the customers, including but not limited to information about customer profiles, preferences, the subscribed services and the dynamic network paths tied to the customer (i.e. customer-to-network maps) which are influenced by the network events/alarms. The databases 142 and 152 further maintain historical data in addition to the current data as described above. The historical data relates to the networking elements, transport links, customers, network events/alarms, past corrective actions taken to alleviate the network event/alarm conditions, and customers affected by each such network event/alarm etc.

In the present disclosure, in one aspect, when a network event/alarm occurs, the network event is trapped and sent to the NMS 138 and NED system 160. In one aspect, the NED system 160 examines the event and applies one or more predetermined or selected rules to determine if the network event is a service affecting event or non-service affecting event, and from the customer-to-network maps, which the NED system maintains. Alternatively, the NED system 160 may include models in the form of computer programs which when executed by a processor in the system enable the system 160 to predict the occurrence of a network event or alarm. The predictive models may utilize the current status of network elements and/or historical data to determine the potential network elements that might be impacted and then determine the customers associated with such elements. The NED system 160 maintains the customer-to-network maps that are periodically or continuously updated (i.e. a dynamically maintained map). The NED system 160 then determines what changes may be made to the customer-to-network maps in view of the network event. For example, if the network event is that there is a cut fiber on TL8, the NED system 160 will determine that services for all customers served through or associated with the path NE3 to TL8 to NE4 will be restored via the path NE3 to TL9 to NE5 since, as noted earlier, both NE4 and NE5 can provide the same services to the customers via NE3. On the other hand, if the network event relates to a failure on a card in NE1 that holds the TL6 interface, then NED will determine from the customer-to-network map and other information all customers or CPEs that are associated with the NE1 and NE3 path. In this example, CPE1-CPE2 are the affected customers. The NED system 160 further determines the current status of the problems, for example, by continually retrieving information relative to the repairs being performed by service personnel to fix the problem. Alternatively, such information may be sent to the NED system 160 by service center trouble-ticketing systems (not shown) or obtained by sending a query to such systems. The NED system 160, in another aspect, also determines the impact of the network event, such as whether there is a complete service disruption, partial service disruption, a delay in the service or another performance degradation. The NED system 160 also determines an estimated time to restore the service, which may be done from the trouble-ticketing information, from historical database or utilizing a predictive model.

In one aspect, the NED system 160 updates the CRM database 152 and applications that reflects the affected services and the affected customers. If a customer service representative, such as 156a-156c receives a call from an affected customer, such as a customer 172, then the customer representative may inform the customer of the nature of the affected service, status of repairs and estimated time for restoring the service, etc. In another aspect, the NED system 160 may send a message to the IVR 155, which plays a recorded message to the customer, such as customer 172, upon receiving a call from the customer. In another aspect, the NED system 160 may directly inform the customer 172 by any of the available methods, such as by initiating a call to a customer telephone number and playing a recorded message, sending an e-mail to a customer provided e-mail address, or posting a message on a web page that the customer can access. The message may be sent during certain times of a day as specified or desired by the customer. The system may choose to inform a selected number of customers or all of the customers, depending on the nature of the service affected, and whether the customer has requested or signed up with service provider to receive such a message.

If the network event status changes, the NED system 160 updates all of the relevant databases as described above and updates the messages accordingly. Once the network event is no longer a service affecting event or the problem has been resolved, a final clear event signal is sent by the system 160 indicating that the service has been restored to an acceptable level. The NED system 160 then adjusts or updates the customer-to-network maps to reflect the change in the network event status and sends final inbound messages (internal to the system such as to databases) and outbound messages (external to the system, such as customers webpage).

Yet in another aspect, the NED system 160 may perform some or all of the aspects noted above if the service provider decides to change a particular service that may be unrelated to a network event or alarm, for example, increasing the available bandwidth to certain customers in a certain geographical area. Although the event results in upgrading an existing service and is not a service affecting event that negatively impact the service, it may still be desirable for the service provider to inform the affected customers either because this may improve customer relations and/or to avoid receiving calls or queries from such customers. The NED system 160 upon receiving information about such an event may update the relevant databases and inform the customers of the change.

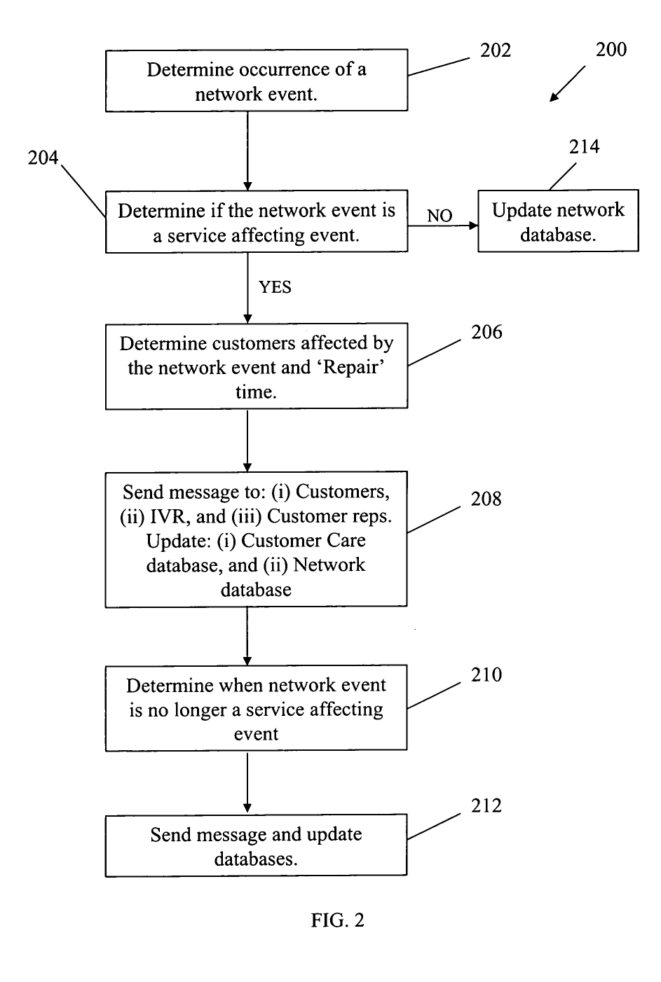

FIG. 2 shows a flow diagram of a method 200 according to one aspect of the present disclosure. As shown in block 202, the method determines the occurrence of a network event. In the method, this may be done by receiving a signal relating the occurrence of a network event or by using a predictive model. As shown in block 204, the method determines if the network event is a service affecting event. If the network event is not a service affecting event, the network database is updated to reflect the status (see block 214). Otherwise, the method determines the customers that may be affected by the network event and the estimated time of repair. (see block 206). The method then performs one or more tasks, including updating databases, customer-to-network maps, sending inbound and outbound messages as shown in block 208. Once the network event is no longer the service affecting event, (see block 210), messages are again sent and databases updated to reflect the change in network status (see block 212).

Thus, as described above, the present disclosure provides an automated method and system that determines in real-time the services and customers affected by an event, which may be a network event or alarm or a change made by the service provider. The method and system also may proactively update network and customer databases, continually update the status of the affected services and send inbound and outbound messages. The method and system also may determine the impact on customers based on historical data and/or by using predictive models. The system and method also may modify the business rules in use or create or implement new rules. Proactively notifying the customers of a service affecting event, updating the IVR and customer care database for the impacted customers in the call centers can improve the service level and reduce the volume of calls from customers reporting a problem with the services. It should be noted that the methods and systems have been described by way of a DSL communications network, only as an example of a network and is not to be taken as a limitation. The methods and systems are equally applicable to any work flow, process or a network that is used to provide services to customers over a distribution network, including a utility (such as electric power, gas, eater, etc,) service distribution network, a cable television network, a satellite television network, a telephone (land or satellite) network or a combination of such network or portions thereof.

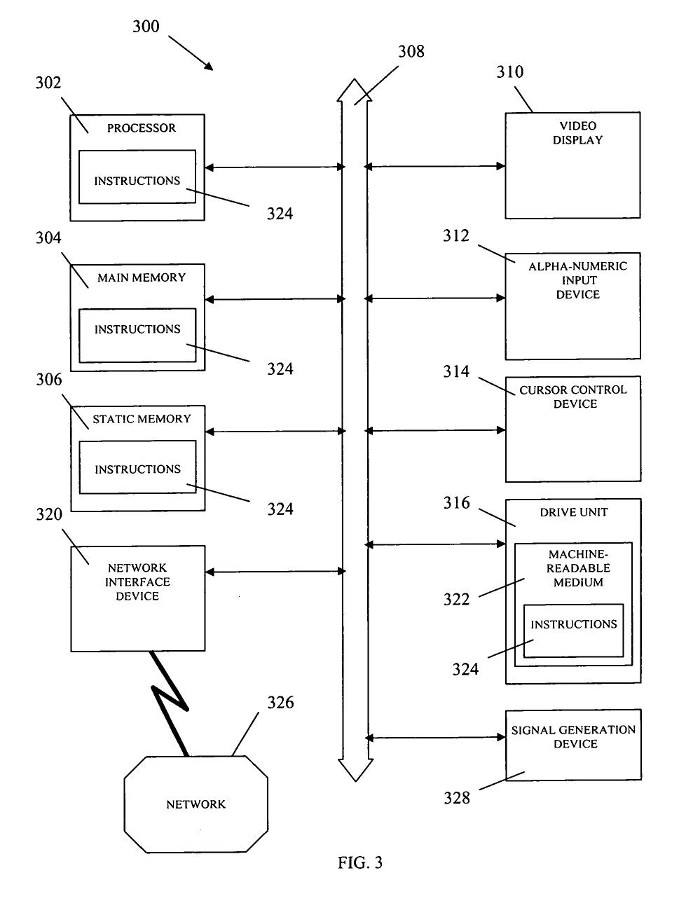

FIG. 3 is a diagrammatic representation of a machine in the form of a computer system 300 that may be utilized as a server for the NED system 160. The computer system 300 has access to the databases noted above and within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a set-top box (STB), a Personal Digital Assistant (PDA), a cellular telephone, a mobile device, a palmtop computer, a laptop computer, a desktop computer, a personal digital assistant, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine. It will be understood that a device of the present invention includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 300 may include a processor 302 (e.g., a central processing unit (CPU), a graphics processing unit (GPU), or both), a main memory 304 and a static memory 306, which communicate with each other via a bus 308. The computer system 300 may further include a video display unit 33 (e.g., a liquid crystal display (LCD), a flat panel, a solid state display, or a cathode ray tube (CRT)). The computer system 300 may include an input device 312 (e.g., a keyboard), a cursor control device 314 (e.g., a mouse), a disk drive unit 316, a signal generation device 318 (e.g., a speaker or remote control) and a network interface device 320.

The disk drive unit 316 may include a machine-readable medium 322 on which is stored one or more sets of instructions (e.g., software 324) embodying any one or more of the methodologies or functions described herein, including those methods illustrated in herein above. The instructions 324 may also reside, completely or at least partially, within the main memory 304, the static memory 306, and/or within the processor 302 during execution thereof by the computer system 300. The main memory 304 and the processor 302 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations In accordance with various embodiments of the present invention, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 324, or that which receives and executes instructions 324 from a propagated signal so that a device connected to a network environment 326 can send or receive voice, video or data, and to communicate over the network 326 using the instructions 324. The instructions 324 may further be transmitted or received over a network 326 via the network interface device 320.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the invention is considered to include any one or more of a machine-readable medium or a distribution medium, as listed herein and including art-recognized equivalents and successor media, in which the software implementations herein are stored.

Although the present disclosure describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are merely representational and may not be drawn to scale. Certain proportions thereof may be exaggerated, while others may be minimized. Accordingly, the specification and drawings are to be regarded in an illustrative rather than a restrictive sense.

Such embodiments of the disclosed subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the detailed Description, with each claim standing on its own as a separate embodiment.

What is claimed is:

1. A computer readable medium accessible to a processor comprising a computer program embedded within the computer readable medium, the computer program comprising:
a set of instructions to receive a signal relating to occurrence of a network event;
a set of instructions to determine if the network event is a service affecting event;
a set of instructions to determine customers affected by the network event; and
a set of instructions to send a message relating to the affected service.

2. The computer readable medium of claim 1, wherein the computer program further comprises a set of instructions to access a customer-to-network map to identify the customers affected by the network event.

3. The computer readable medium of claim 1, wherein the computer program further comprises a set of instructions that sends the message to one of (i) a customer premise equipment, (ii) a voice recognition system, and (iii) a customer care database.

4. The computer readable medium of claim 1, wherein the computer program further comprises a set of instructions that determines a change in status of the network event and sends a message relating to the change in the status.

5. The computer readable medium of claim 1, wherein the computer program further comprises a set of instructions to determine an extent of the affected service.

6. The computer readable medium of claim 5, wherein the extent of the affected service determined is one of (i) a partial disruption of the service, (ii) a complete disruption of the service, and (iii) an identity of a network element that is associated with the network event.

7. The computer readable medium of claim 1, wherein the computer program further comprises a set of instructions that determines if the network event is a service affecting event as one (i) in real-time, (ii) using a predictive model, and (iii) based on historical data.

8. A method for providing a service over a communications network, comprising;
determining occurrence of a network event;
determining if the network event is a service affecting event; and
initiating a response relating to customers affected by the network event.

9. The method of claim 8, wherein determining the occurrence of the network event is one of (i) determining the occurrence in real-time, and (ii) predicting the occurrence based on a predefined rule.

10. The method of claim 8, wherein initiating the response comprises sending a message to one of (i) a customer call center that is adapted to receive communication from the customers, (ii) an interactive voice recognition system that is operative to communicate with the customers, and (iii) the customers.

11. The method of claim 8 further comprising:
determining a customer-to-network map that defines a network path utilized to provide the service to the customers; and
determining the customers affected by the network event associated with the network path that provides the service to the customers.

12. The method of claim 8 further comprising:
providing a database that stores a relationship among a plurality of network elements that provide the service;
providing a database that stores customer information; and
correlating the relationship among the plurality of network elements with the customer information to determine the customers affected by the occurrence of the network event.

13. The method of claim 12, wherein the customer information includes at least one of (i) a customer identification, (ii) a service provided to a customer, (iii) a transport link providing the service to a customer, (iv) a customer preference relating to receiving a notification, (v) an identification of a customer premise equipment receiving the service, and (vi) a network switch that routes the service to a customer.

14. The method of claim 7 further comprising determining when the network event no longer is a service affecting event and sending a message that indicates that the service is no longer affected by the network event.

15. The method of claim 14 further comprising updating the customer-to-network map when the network event is no longer a service affecting event.

16. A system for use in a communications network, comprising:
a first database that stores information about network elements and transport links that provide a network service to a plurality of customers;
a second database that stores information relating to the plurality of customers;
a server having a processor that has access to a computer program and the first and second databases, the processor utilizing the computer program to determine occurrence of a network event and to send a message in response to the occurrence of the network event.

17. The system of claim 11, wherein the first database comprises a customer-to-network map that defines a network path that provides the network service to the plurality of customers.

18. The system of claim 17, wherein the processor further determines identity of customers from the plurality of customers that are affected by the occurrence of the network event.

19. The system of claim 16, wherein the processor sends the message to one of (i) a customer device, (ii) a third database that is accessible to a service representative from a remote location, and (iii) a voice recognition system.

20. The system of claim 16, wherein the processor determines if the network event is a service affecting event in real-time or predicts by utilizing a rule.
